(19) United States
(12) Patent Application Publication
(10) Pub. No.: US 2018/0207827 A1
(43) Pub. Date: Jul. 26, 2018

(54) KNIFE AND SHEATH ASSEMBLY

(71) Applicants: Cory Owen NYKOLUK, (US); CUTTWAY PRODUCTS CO., LTD., TAICHUNG CITY (TW)

(72) Inventor: Li-Wei HSIEH, YUANLI TOWNSHIP (TW)

(21) Appl. No.: 15/880,102

(22) Filed: Jan. 25, 2018

(30) Foreign Application Priority Data
Jan. 25, 2017 (TW) 106201464

(51) Int. Cl. B26B 29/02; B26B 3/06

(52) U.S. Cl. CPC B26B 29/025; B26B 3/06

(57) ABSTRACT

A knife and sheath assembly includes a sheath defining therein a knife accommodation portion; an engagement and release unit including a pivot hole pivotally coupled to said sheath, and operating portion and an engagement portion; a knife including a cutter blade insertable into the knife accommodation portion, a grip, a plurality of retaining grooves arranged in series on a back side thereof between the cutter blade and the grip for engagement with the engagement portion of the engagement and release unit in a selective manner. In an alternate form, the knife and sheath assembly includes a sheath defining a knife accommodation portion, a guide-in portion and a guide-out portion, and a knife including a cutter blade insertable into the knife accommodation portion, a grip, a guide-in edge for engagement with the guide-in portion of the sheath and a guide-out edge for engagement with the guide-out portion of the sheath.

### BACKGROUND OF THE INVENTION

### 1. Field of the Invention

The present invention relates to knife technology, and more particularly, to a knife and sheath assembly.

### 2. Description of the Related Art

In a known knife and sheath combination structure, the knife and the sheath have mating engagement portions for engagement therebetween. However, in this known design, the knife is easy to get rid of its sheath, resulting in application inconvenience. Therefore, the conventional knife and sheath combination structure has drawbacks and still needs to be improved.

### SUMMARY OF THE INVENTION

The present invention has been accomplished under the circumstances in view. It is the main object of the present invention to provide a knife and sheath assembly, which effectively enhances the engagement effect between the knife and the sheath.

To achieve this and other objects of the present invention, a knife and sheath assembly comprises a sheath defining therein a knife accommodation portion; an engagement and release unit comprising a pivot hole pivotally coupled to the sheath, an operating portion and an engagement portion; a knife comprising a cutter blade insertable into the knife accommodation portion of the sheath, a grip connected to the cutter blade and a plurality of retaining grooves arranged in series on a back side thereof between the cutter blade and the grip for the engagement of the engagement portion of the engagement and release unit in a selective manner.

Preferably, the engagement and release unit further comprises a spring adapted for imparting an elastic restoring energy to return the engagement and release unit.

Preferably, the sheath further comprises a guide-in portion and a guide-out portion; the knife further comprises a guide-in edge for engagement with the guide-in portion of the sheath, and a guide-out edge for engagement with the guide-out portion of the sheath.

Preferably, the knife and sheath assembly further comprises a pivot unit connected to the sheath for the connection of the engagement and release unit pivotally.

Preferably, the sheath further comprises an axle hole; the pivot unit further comprises a pivot axle having a shank inserted through the axle hole of the sheath.

Preferably, the pivot unit further comprises a pivot axle having a screw hole axially defined in one end thereof, and a screw bolt threaded into the screw hole of the pivot axle to pivotally secure the pivot axle to the sheath.

In an alternate form of the present invention, a knife and sheath assembly comprises a sheath comprising a knife accommodation portion, a guide-in portion and a guide-out portion, and a knife comprising a cutter blade insertable into the knife accommodation portion of the sheath, a grip connected to the cutter blade, a guide-in edge for engagement with the guide-in portion of the sheath, and a guide-out edge for engagement with the guide-out portion of the sheath.

Preferably, the knife further comprises a locating hole. Further, the guide-in edge and the guide-out edge are defined in the locating hole.

Thus, the invention effectively enhances the engagement effect between the knife and the sheath.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic assembly view of a knife and sheath assembly in accordance with the present invention.

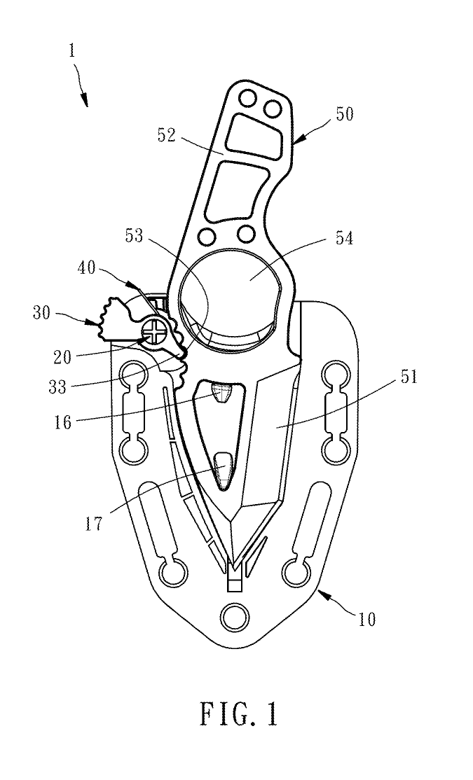

FIG. 2 is an elevational view of the sheath of the knife and sheath assembly in accordance with the present invention.

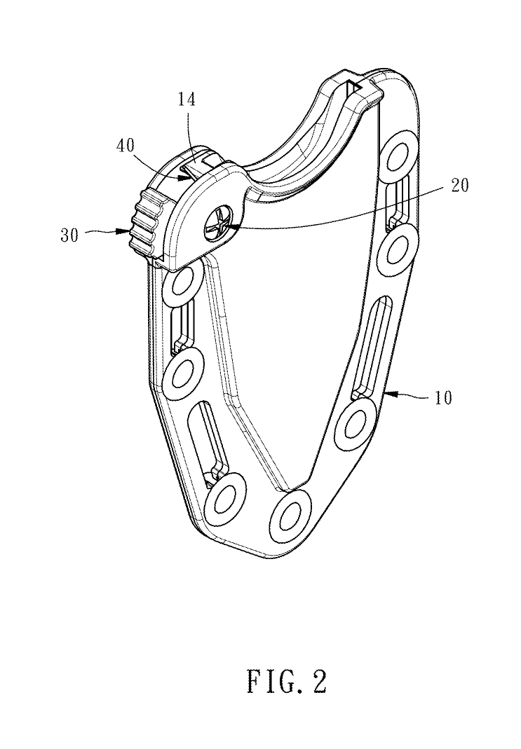

FIG. 3 is an exploded view of the sheath shown in FIG. 2.

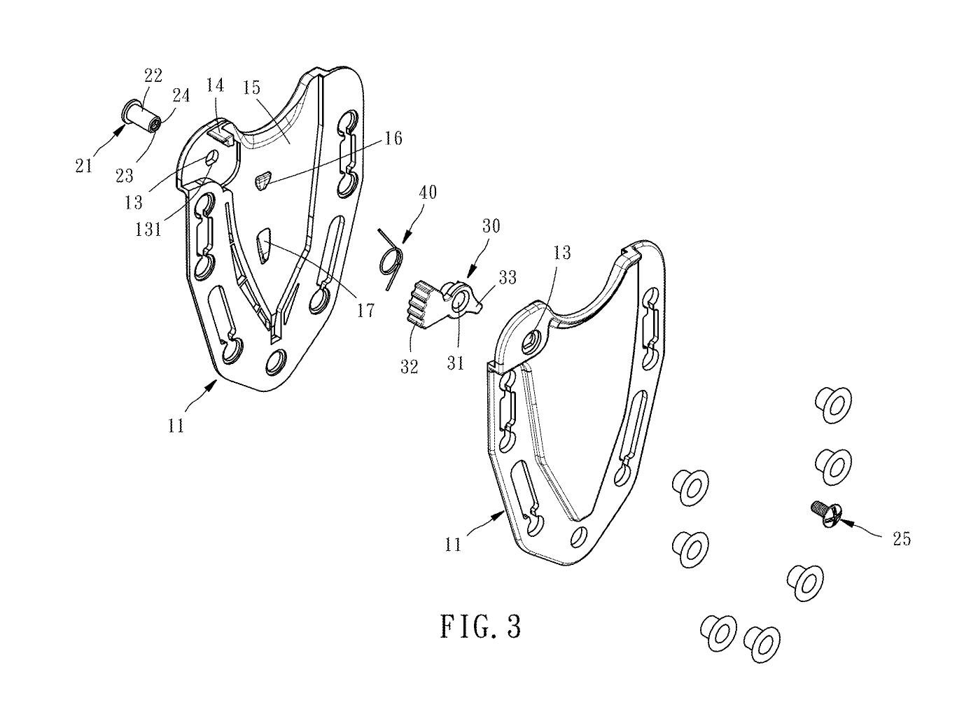

FIG. 4 corresponds to FIG. 3 when viewed from another angle.

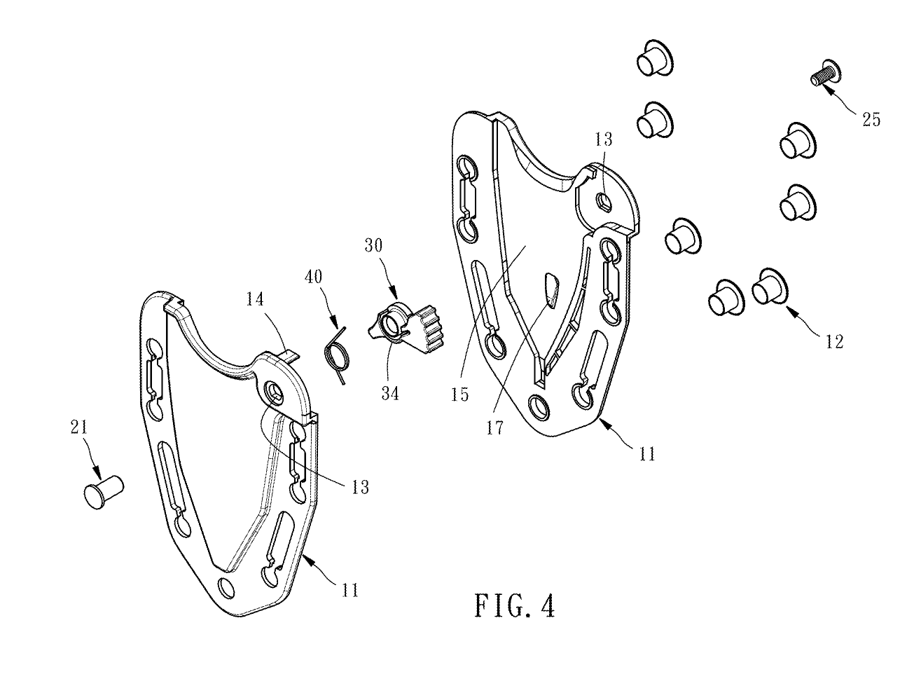

FIG. 5 is a schematic front view of the present invention, illustrating the knife inserted into the sheath.

FIG. 6 is a schematic operational view illustrating the operation of detachment of the knife from the sheath.

### DETAILED DESCRIPTION OF THE INVENTION

Referring to the annexed drawings in detail, a knife and sheath assembly 1 in accordance with the present invention comprises a sheath 10, a pivot unit 20, an engagement and release unit 30, a spring 40 and a knife 50.

The sheath 10, comprising two sheath shells 11 fastened together with rivets 12. The two sheath shells 11 each comprise an axle hole 13, a stop edge 131 defined in the axle hole 13, a knife accommodation portion 15, and a guide-out portion 17. One sheath shell 11 further comprises a spring abutment portion 14 and a guide-in portion 16.

The pivot unit 20 comprises a pivot axle 21 having a shank 22 inserted through the axle holes 13 of the two sheath shells 11 of the sheath 10 and a screw hole 24 axially defined in one end of the shank 22, and a screw bolt 25 threaded into the screw hole 24 of the pivot axle 21 to secure the two sheath shells 11 of the sheath 10 together.

Further, the shank 22 defines a stop edge 23.

The engagement and release unit 30 comprises a pivot hole 31 pivotally coupled to the sheath 10, an operating portion 32 disposed at one side relative to the pivot hole 31, an engagement portion 33 disposed at an opposite side relative to the pivot hole 31, and a spring mount 34 arranged around the pivot hole 31.

The spring 40 is mounted to the sheath 10 and the engagement and release unit 30 for returning the engagement and release unit 30, having one end thereof stopped against the spring mount 34 of the engagement and release unit 30 and an opposite end thereof stopped against the spring abutment portion 14 of the sheath 10.

The knife 50 comprises a cutter blade 51 insertable into the knife accommodation portions 15 of the two sheath shells 11 of the sheath 10, a grip 52 connected to the cutter blade 51, a plurality of retaining grooves 53 arranged in series on a back side thereof between the cutter blade 51 and the grip 52 for the engagement of the engagement portion 33 of the engagement and release unit 30 in a selective manner, and a finger hole 54 defined in between the cutter blade 51 and the grip 52.

Preferably, the retaining grooves 53 of the knife 50 are smoothly arched.

The knife 50 further comprises a locating hole 55 located on the cutter blade 51, a guide-in edge 56 for engagement with the guide-in portion 16 of the sheath 10, and a guide-out edge 57 for engagement with the guide-out portion 17 of the sheath 10. Further, the guide-in edge 56 and the guide-out edge 57 are respectively defined in the locating hole 55.

The operation of the knife and sheath assembly 1 is outlined hereinafter.

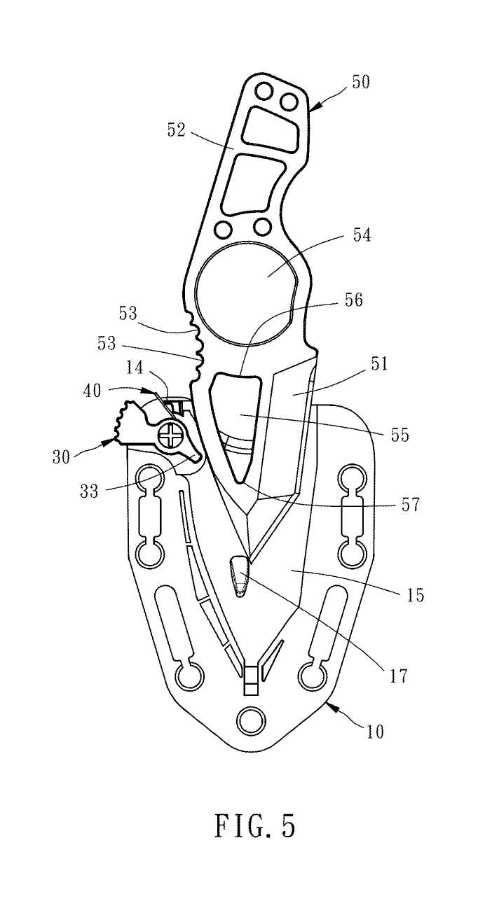

When plugging the knife 50 into the sheath 10, as illustrated in FIG. 5, insert the cutter blade 51 of the knife 50 into the knife accommodation portions 15 of the two sheath shells 11 of the sheath 10 to move the retaining grooves 53 over the engagement portion 33 of the engagement and release unit 30 against the spring force of the spring 40 till that the guide-in edge 56 of the knife 50 is forced into engagement with the guide-in portion 16 of the heath 10 and the guide-out edge 57 of the knife 50 is forced into engagement with the guide-out portion 17 of the sheath 10. During this operating procedure, the user needs not to bias the engagement and release unit 30.

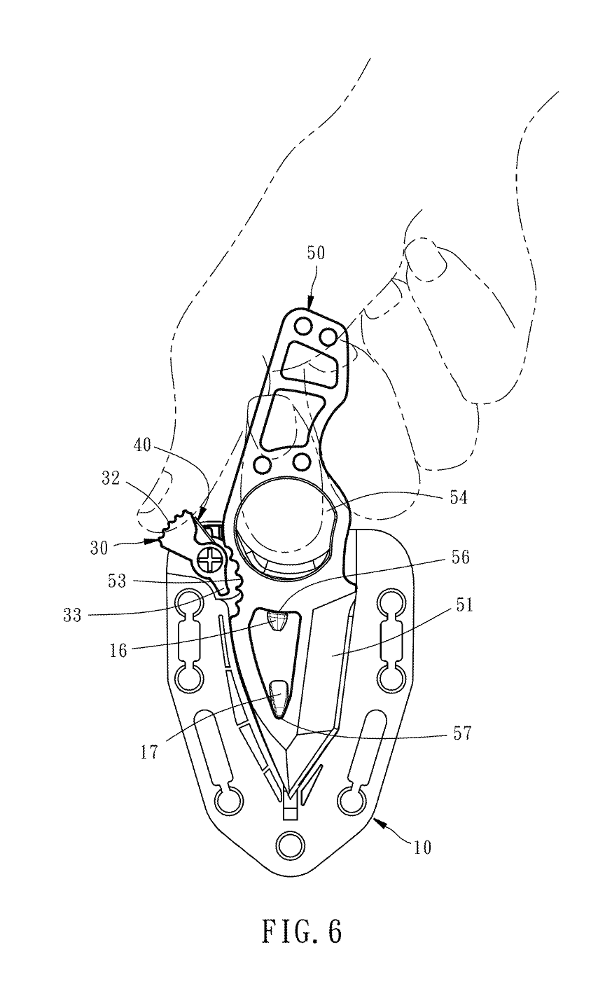

When detaching the knife 50 from the sheath 10, as illustrated in FIG. 6, hook the index finger in the finger hole 54 of the knife 50, and then bias the operating portion 32 of the engagement and release unit 30 with the thumb to overcome the spring force of the spring 40 to disengage the engagement portion 33 of the engagement and release unit 30 from the retaining grooves 53 of the knife 50, thereby disengaging the guide-in edge 56 of the knife 50 from the guide-in portion 16 of the sheath 10 and also disengaging the guide-out edge 57 of the knife 50 from the guide-out portion 17 of the sheath 10 for allowing removal of the knife 50 from the sheath 10.

In an alternate form of the present invention, the knife and sheath assembly 1 comprises:

a sheath 10 comprising a knife accommodation portion 15;

an engagement and release unit 30 comprising a pivot hole 31 pivotally connected to the sheath 10, an operating portion 32 and an engagement portion 33; and

a knife 50 comprising a cutter blade 51 insertable into the knife accommodation portion 15 of the sheath 10, a grip 52 connected to the cutter blade 51, a plurality of retaining grooves 53 arranged in series on a back side thereof between the cutter blade 51 and the grip 52 for engagement with the engagement portion 33 of the engagement and release unit 30 in a selective manner.

In another alternate form of the present invention, the knife and sheath assembly 1 comprises:

a sheath 10 comprising a knife accommodation portion 15, a guide-in portion 16 and a guide-out portion 17;

a knife 50 comprising a cutter blade 51 insertable into the knife accommodation portion 15 of the sheath 10, a grip 52 connected to the cutter blade 51, a guide-in edge 56 for engagement with the guide-in portion 16 of the sheath 10 and a guide-out edge 57 for engagement with the guide-out portion 17 of the sheath 10.

Other modifications can be made without departing from the sprit and scope of the present invention.

For example, the pivot unit 20 can be formed integral with or mounted at the sheath 10, or, the pivot unit 20 can be formed integral with or mounted at the engagement and release unit 30.

In conclusion, the invention enhances positive engagement between the knife and the sheath to accurately achieve the expected purpose.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A knife and sheath assembly, comprising:
a sheath comprising a knife accommodation portion;
an engagement and release unit comprising a pivot hole pivotally coupled to said sheath, an operating portion and an engagement portion; and
a knife comprising a cutter blade insertable into said knife accommodation portion of said sheath, a grip connected to said cutter blade, a plurality of retaining grooves arranged in series on a back side thereof between said cutter blade and said grip for the engagement of said engagement portion of said engagement and release unit in a selective manner.

2. The knife and sheath assembly as claimed in claim 1, further comprising a pivot unit connected to said sheath for pivot connection with said engagement and release unit.

3. The knife and sheath assembly as claimed in claim 2, wherein said sheath further comprises an axle hole; said pivot unit comprises a pivot axle, said pivot axle comprising a shank inserted through said axle hole of said sheath.

4. The knife and sheath assembly as claimed in claim 2, wherein said pivot unit further comprises a pivot axle, a screw hole axially defined in one end of said pivot axle, and a screw bolt threaded into said screw hole to pivotally secure said pivot axle to said sheath.

5. The knife and sheath assembly as claimed in claim 1, further comprising a spring for imparting an elastic restoring energy to return said engagement and release unit.

6. The knife and sheath assembly as claimed in claim 5, wherein said sheath further comprises a guide-in portion and a guide-out portion; said knife further comprises a guide-in edge for engagement with said guide-in portion of said sheath, and a guide-out edge for engagement with said guide-out portion of said sheath.

7. The knife and sheath assembly as claimed in claim 1, wherein said sheath further comprises a guide-in portion and a guide-out portion; said knife further comprises a guide-in edge for engagement with said guide-in portion of said sheath, and a guide-out edge for engagement with said guide-out portion of said sheath.

8. The knife and sheath assembly as claimed in claim 7, wherein said knife further comprises a locating hole; said guide-in edge and said guide-out edge are defined in said locating hole.

9. A knife and sheath assembly, comprising:
a sheath comprising a knife accommodation portion, a guide-in portion and a guide-out portion;
a knife comprising a cutter blade insertable into said knife accommodation portion of said sheath, a grip connected to said cutter blade, a guide-in edge for engagement with said guide-in portion of said sheath and a guide-out edge for engagement with said guide-out portion of said sheath.

10. The knife and sheath assembly as claimed in claim 9, wherein said knife further comprises a locating hole; said guide-in edge and said guide-out edge are defined in said locating hole.
